(19) United States
(12) Patent Application Publication
(10) Pub. No.: US 2021/0387698 A1
(43) Pub. Date: Dec. 16, 2021

(54) Ski assembly

(71) Applicant: MK Evol AS, Alta (NO)

(72) Inventor: Morten Kjellmann, Alta (NO)

(21) Appl. No.: 17/287,119

(22) PCT Filed: Oct. 21, 2019
(86) PCT No.: PCT/EP2019/078487

§ 371 Date: Apr. 21, 2021

(30) Foreign Application Priority Data
Oct. 23, 2018 (NO) 20181362

(51) Int. Cl. B62M 27/02

(52) U.S. Cl. CPC B62M 27/02; B60B 27/0063; B62M 2027/025

(57) ABSTRACT

The present invention provides a ski assembly (39) for mounting on a front wheel hub unit (40) of a wheel-drive vehicle, wherein the wheel hub unit comprises a brake caliper bracket fastened to a bracket mount on the hub unit by caliper mounting bolts, the ski assembly comprises a ski element (42) and a fastening assembly, wherein the fastening assembly comprises an arm (43) having a first end (44) and a second end (45), the first end is pivotably connected to the ski element (42) around a pivot axis being transverse to the longitudinal direction of the ski element and the second end (45) comprises a ski fastening bracket (46) comprising at least two mounting bolt holes (47) arrangeable at positions corresponding to the positions of the caliper mounting bolts, such that the second end may be rigidly connected to the bracket mount.

### FIELD OF THE INVENTION

The present invention concerns the technical field of ski assemblies, more specifically a ski assembly for conversion of a front wheel vehicle to a front ski vehicle.

### BACKGROUND

Ski assemblies or ski kits for the conversion of a wheel-drive vehicle, such as all-terrain vehicles (ATV's) and utility terrain vehicles (UTV's) to vehicles having a set of skis in front are well known.

The prior art ski assemblies are commonly fastened to the front wheels of a vehicle by various means or requires the removal of the front wheels to be fastened.

Examples of prior art ski assemblies are disclosed in US 2017/0021853 A1, U.S. Pat. No. 3,321,211 A and U.S. Pat. No. 4,577,876 A.

The aim of the present invention is to provide an improved ski assembly for conversion of a front wheel vehicle to a front ski vehicle. The ski assembly alleviates or avoids at least some of the disadvantages of the prior art ski assemblies.

### SUMMARY OF THE INVENTION

The present invention is defined by the attached claims and in the following:

In a first aspect, the present disclosure provides a ski assembly for mounting on a front wheel hub unit of a wheel-drive vehicle, wherein the wheel hub unit comprises a brake caliper bracket fastened to a bracket mount on the hub unit by caliper mounting bolts, the ski assembly comprises a ski element and a fastening assembly, wherein
the fastening assembly comprises an arm having a first end and a second end, the first end is pivotably connected to the ski element around a pivot axis being transverse to the longitudinal direction of the ski element and the second end comprises a ski fastening bracket comprising at least two mounting bolt holes arrangeable at positions corresponding to the positions of the caliper mounting bolts, such that the second end may be rigidly connected to the bracket mount.

In an embodiment of the first aspect, the ski assembly comprises at least two ski assembly mounting bolts, each bolt dimensioned to replace a caliper mounting bolt and having a length such that the ski fastening bracket may be rigidly connected to the bracket mount via the brake caliper bracket.

In other words, the brake caliper bracket is fastened to a bracket mount on the wheel hub unit by caliper mounting bolts arranged in corresponding caliper mounting bolt holes in the bracket mount. The at least two mounting bolt holes of the ski fastening bracket may be aligned with the caliper mounting bolt holes, and the ski fastening bracket may be connected to the bracket mount via the brake caliper bracket, the mounting bolt holes and the caliper mounting bolt holes by the at least two ski assembly mounting bolts.

In an embodiment of the first aspect, the ski element comprises a cut out through which a lower section of a wheel mounted on the wheel hub unit may extend. The cut out is preferably dimensioned such that the wheel is not in contact with the ski element, i.e. such that the wheel may rotate freely relative the ski element.

In an embodiment of the first aspect, the ski element comprises at least a first support rib arranged in the longitudinal direction of the ski element. The ski element may comprise a first support rib and a second support rib arranged in the longitudinal direction of the ski element, wherein the support ribs are arranged on opposite sides of the cut out.

In an embodiment of the first aspect, the first end is pivotably connected to the ski element at the first support rib.

In a second aspect, the present invention provides a method for mounting a ski assembly to the front wheel hub unit of a wheel-drive vehicle, the wheel hub unit comprises a brake caliper bracket fastened to a bracket mount on the wheel hub unit by caliper mounting bolts, the method comprising the steps of:
providing a ski assembly according to any embodiment of the first aspect;
unscrewing the caliper mounting bolts; and
connecting the ski fastening bracket to the bracket mount, preferably by use of ski assembly mounting bolts.

The term “pivotably connected” is intended to mean that two features/elements are connected/connectable such that they may pivot relative to each other. By use of the term it is considered implicit that the two features are connected by a suitable pivot connection.

### SHORT DESCRIPTION OF THE DRAWINGS

The present invention is described in detail by reference to the following drawings:

FIG. 1 is a perspective side view of a vehicle featuring an exemplary ski assembly according to the present invention.

FIG. 2 is a perspective rear view the vehicle in FIG. 1.

FIG. 3 is an enlarged perspective view of a track kit of the vehicle in FIG. 1.

FIG. 4 is a side view of a track kit mounted to the vehicle in FIG. 1.

FIG. 5 is a perspective top view of the track kit in FIG. 4.

FIG. 6 is a perspective view of the exemplary ski assembly arranged on the front wheels of the vehicle in FIG. 1.

FIG. 7 is an enlarged view of the ski assembly in FIG. 6.

### DETAILED DESCRIPTION OF THE INVENTION

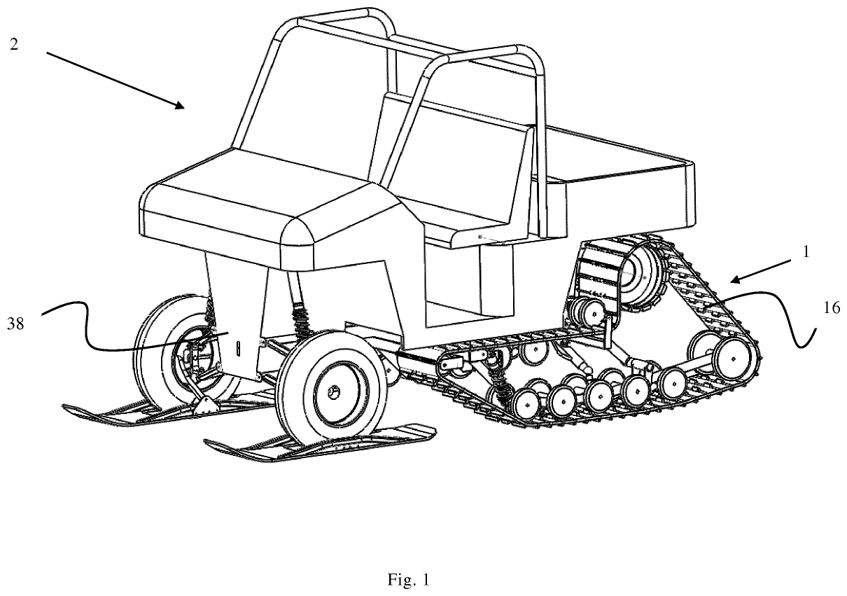

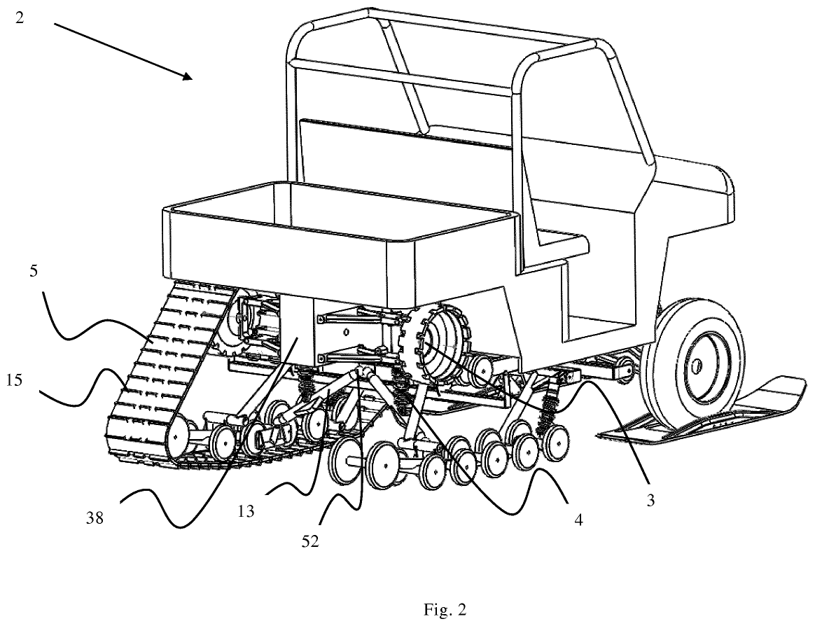

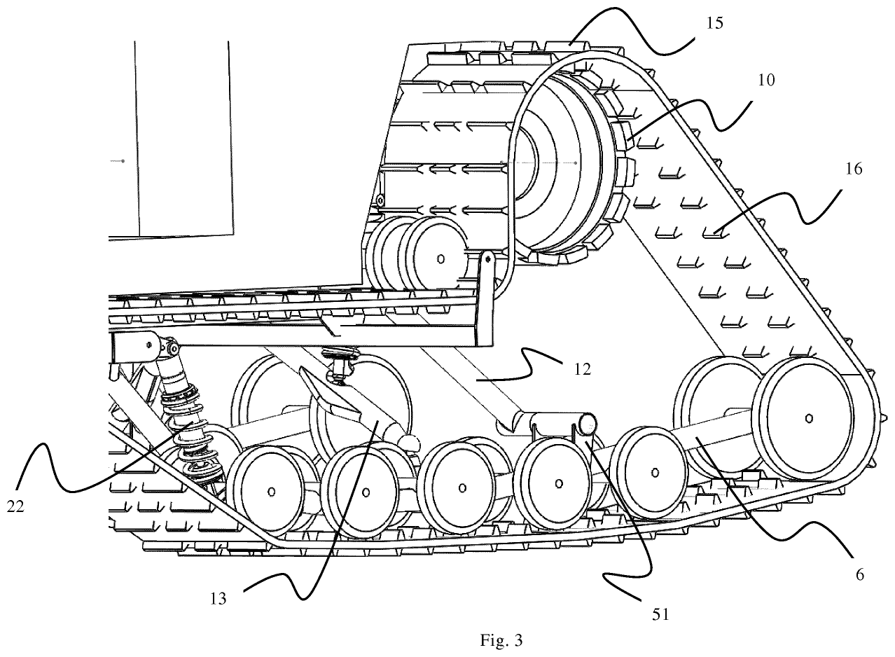

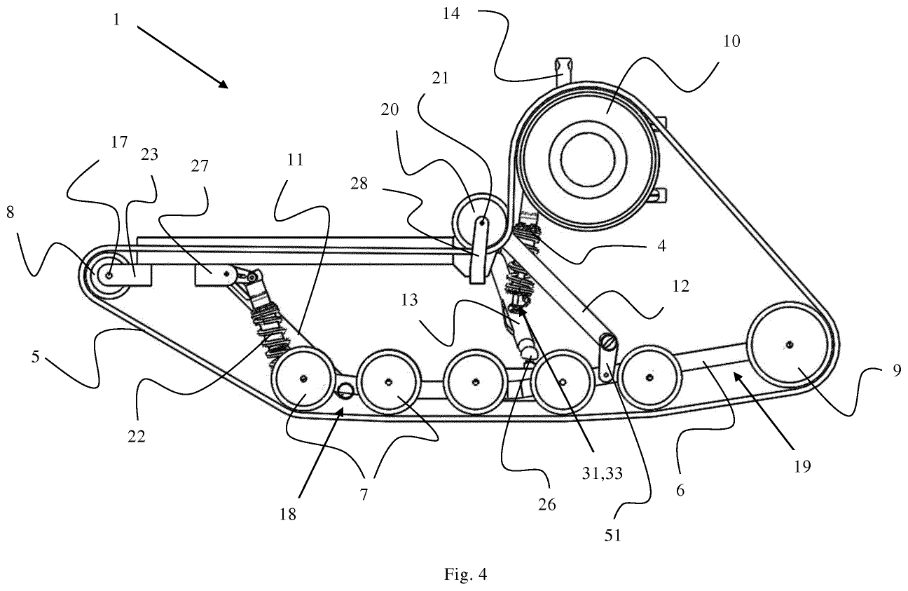

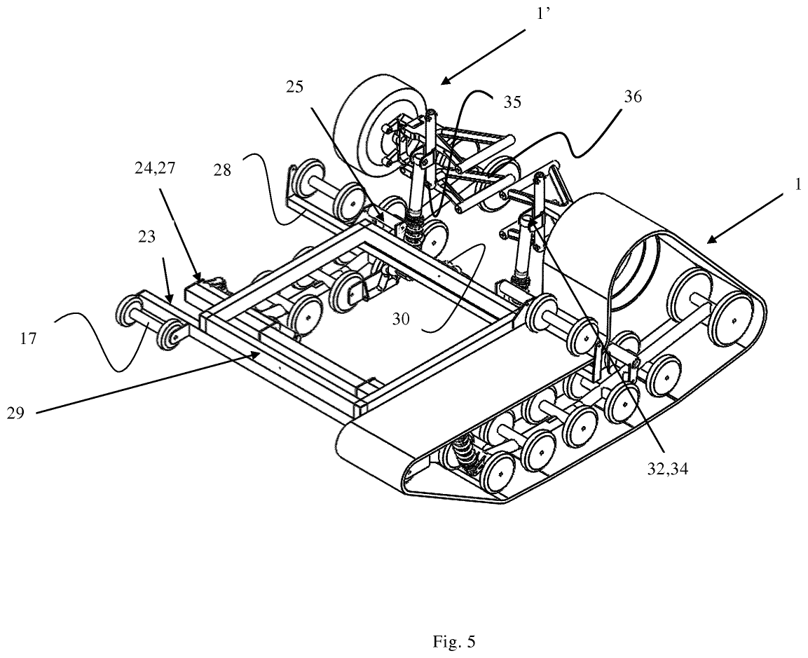

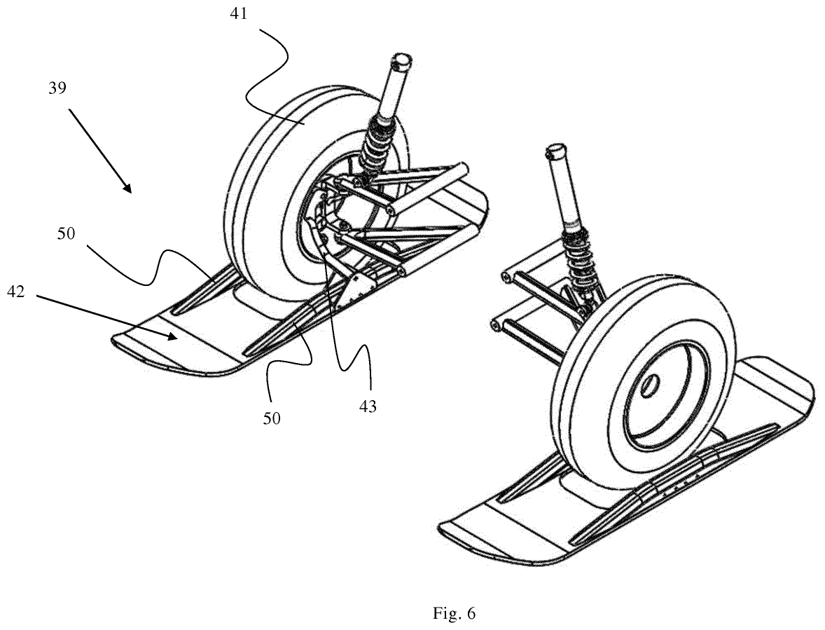

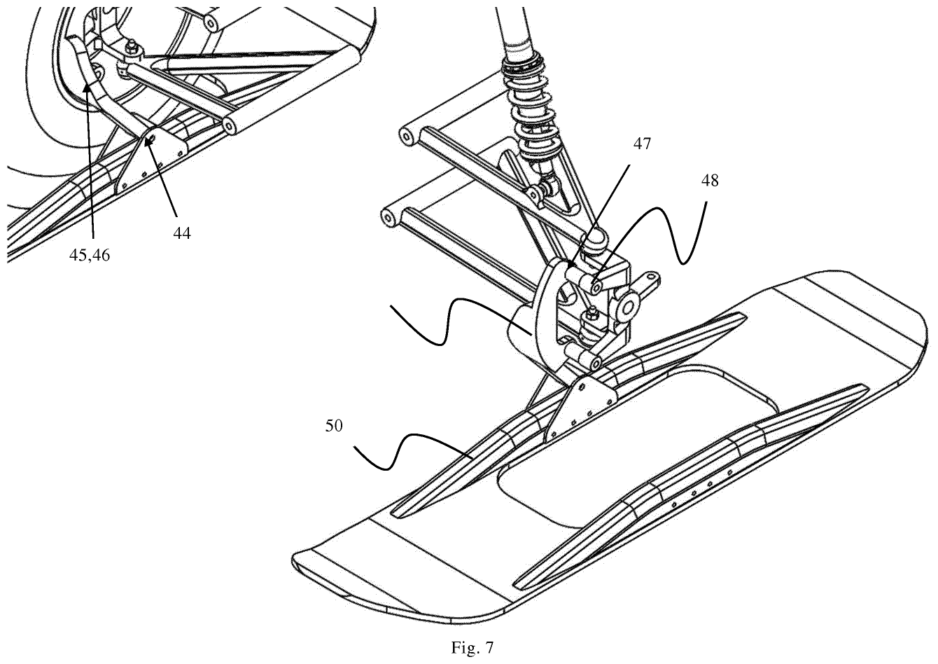

A vehicle 2 comprising an exemplary ski assembly 39 and a track kit is shown in FIGS. 1 and 2. Further details of the track kit are shown in FIGS. 3 to 5 and further details of the ski assembly 39 are shown in FIGS. 6 and 7.

The track kit is described by use of a vehicle 2 featuring a chassis 38, a rear drive axle featuring two opposite wheel hub units 3, and a double A-arm rear suspension having a rear shock absorber 4 for each of the wheel hub units. However, the track kit may easily be adapted for vehicles featuring other types of rear suspensions.

The vehicle 2 is further provided with the exemplary ski assembly 39 mounted on each of the front wheel hub units 40. Details of the ski assemblies are described below by reference to FIGS. 6 and 7.

The track kit features two track assemblies 1,1′ interconnected by a support framework 29. Each track assembly comprises an endless ground track 5, a front idler wheel 8, a center beam 6 (i.e. intermediate support member) comprising multiple intermediate idler wheels 7 (i.e. at least one track engaging element), a rear idler wheel 9, a drive wheel 10, a pinch wheel 20, a front swing arm 11 and a rear swing arm 12 (i.e. at least one swing arm) and a shock absorber connecting assembly 13,14.

The endless track 5 comprises an external side featuring ground lugs 15 for ground engagement and an internal side featuring drive lugs 16 for engagement with the drive wheel 10, see FIGS. 2 and 3. The internal side of the ground track 5 is circumferentially trained around and in contact with the front idler wheel 8, the multiple intermediate idler wheels 7, the rear idler wheel 9 and the drive wheel 10.

The drive wheel 10 of each track assembly 1,1′ is connectable/connected to one of the wheel hub units 3 of the vehicle 2. Although not shown in the drawings, the drive wheels 10 are preferably mounted to the wheel hub units via wheel hub bolts.

The front idler wheel 8 is arranged at a level above the multiple intermediate idler wheels 7 and comprises a front idler wheel axle 17 rigidly connectable/connected to the chassis 38.

The pinch wheel 20 is in contact with the external side of the endless track 5 and is arranged adjacent to the drive wheel 10 and rear of the front idler wheel 8. The pinch wheel 20 and the front idler wheel 8 is arranged such that an upper forward section of the ground track 5, i.e. the section of the ground track 5 extending between the pinch wheel 20 and the front idler wheel 8, is guided at a level below the chassis 38. The pinch wheel 20 comprises a pinch wheel axle 21 rigidly connectable/connected to the chassis 38.

In the track kit, each of the front idler wheel 8, the multiple intermediate idler wheels 7, the rear idler wheel 9 and the pinch wheel 20 features two parallel wheels having a common rotational axis.

The front swing arm 11 is pivotably connected to a front section 18 of the center beam 6 and pivotably connectable/connected to the chassis 38. The rear swing arm 12 is pivotably connected to a rear section 19 of the center beam 6 via a pivot link arm 51 and pivotably connectable/connected to the chassis 38. The pivot link arm 51 is pivotably connected to the rear section of the center beam 6 and a lower end of the rear swing arm 12. The pivot link arm 51 allows the center beam 6 to tilt/pivot in a vertical plane even when connected to both the front swing arm 11 and the rear swing arm 12, such that the center beam 6 may follow the terrain during use. The purpose of the front swing arm 11 is to guide the movement of the center beam 6 such that the tension of the ground track 5 is maintained during vertical movement of the center beam, i.e. the vertical damping movements caused by ground interaction during use, as well as prevent sideways and torsional movement of the center beam 6 relative the chassis 38.

The purpose of the rear swing arm is, in combination with the front swing arm, to prevent sideways and torsional movement of the center beam 6 relative the chassis 38. In other embodiments, the rear swing arm 12 may be removed provided the front swing arm is sufficiently dimensioned to prevent sideways and torsional movement of the center beam 6.

The shock absorber connecting assembly 13,14 features a shock connecting arm 13 having a first end 26 pivotably connected to the center beam 6 and a second end 52 pivotably connectable to the chassis 38. The shock connecting arm 13 is operably connectable/connected to a lower end 31 of a rear shock absorber of the vehicle 2 via a connection 33 arranged between the first end 26 and the second end 52. In the exemplary embodiment, the vehicle features two rear shock absorbers 4. It is noted that the shock absorber connecting assembly 13,14 may easily be adapted/modified for vehicles featuring a single rear shock absorber 4, such as some types of ATVs.

In such cases, the shock connecting arms 13 of the two track kit assemblies may for instance be interconnected by an intermediate shock connecting beam to which a lower end of a single rear shock absorber may be connected.

In other embodiments of the track kit, the shock absorber connecting assembly may comprise any suitable shock connecting arm providing an operable connection between the center beam and a lower end of a rear shock absorber. Various solutions for obtaining an operable connection between a lower end of a rear shock absorber and the center beam would be apparent for the skilled person having knowledge of the present disclosure.

The level of the wheel hub units 3 are fixed relative the chassis by a locking beam 14 (i.e. a rear suspension locking device) arranged to prevent vertical movement of the wheel hub units. In the exemplary embodiment, the locking beam is arranged to lift the level of the wheel hub units relative to the chassis, i.e. the fixed level of the wheel hubs is above the original level of the wheel hubs before attachment of the locking beam. The preferred fixed level will depend on the type of vehicle on which the track kit is mounted and/or the required amount of dampening or suspension travel of the center beam 6. The locking beam 14 is a part of the shock absorber connecting assembly 13,14 and has a first connection 34 connected/connectable to an upper end 32 of the corresponding rear shock absorber 4, a second connection 35 connected/connectable to an upper A-arm 36 of the rear suspension of the vehicle (i.e. a vertically moveable portion of the rear suspension) and a third connection 37 connecting (or for connecting) the locking beam to the chassis 38. In the exemplary embodiment, the locking beam is connected to the chassis via an original connection for an upper end of the rear shock absorber 4.

Although highly advantageous in that the track kit is more easily adapted to various vehicles and lengths of suspension travel, it is not a requirement to fix the level of the wheel hub units 3 to obtain a track kit providing reduced unsprung weight.

The technical effect of having the front idler wheel 8 rigidly connected to the chassis 38, and at least the front swing arm 11 pivotably connected to the chassis 38 and the center beam 6, is that the movement of the center beam (i.e. a lower part of the track kit) is independent of the upper part of the track kit and the chassis. In this manner, the unsprung weight of the track kit (and the converted vehicle) is reduced considerably. Further reduction of the unsprung weight is obtained by any one of the features of having the pinch wheel 20 rigidly connected to the chassis, having the rear shock absorber operably connected to the center beam 6 and having the vertical movement of the wheel hub units 3 fixed/locked relative to the chassis. Compared to a theoretical track kit having track assemblies only connected to the chassis via the wheel hub units, as in prior art track kits, the unsprung weight of the exemplary track kit is reduced by about 50-70%. The reduced unsprung weight provides improved suspension characteristics, driving comfort, durability and practical vehicle speed.

In the track kit, each track assembly 1,1′ also features a front shock absorber 22 pivotably connected to a front section 18 of the center beam and pivotably connected/connectable to the chassis. The front shock absorber 22 ensures that more of the vehicle weight is supported by the track kit. In practice, the front shock absorber shortens the wheelbase of the vehicle and reduces the weight supported by the front steering elements, i.e. the front wheels/ski assemblies of the exemplary embodiment. By reducing the supported weight, the steering characteristics are improved. This effect is especially advantageous when both the front and rear of a vehicle is converted by track kits, since prior art front track kits are heavy and difficult to steer.

The exemplary track kit features a support framework 29 rigidly connected/connectable to the chassis. The support framework features the following connecting elements for each of the track assemblies 1,1′; a first connecting element 23 to which the front idler wheel axle is rigidly connected, a second connecting element 24 to which the rear swing arm 12 is pivotably connected, a third connecting element 25 to which the front swing arm 11 is pivotably connected, a fourth connecting element 27 to which the front shock absorber 22 is pivotably connected, a fifth connecting element 28 to which the pinch wheel axle 21 is rigidly connected and a sixth connecting element 30 to which the shock connecting arm 13 is pivotably connected.

The support framework 29 may advantageously be modular. A modular framework may for instance be comprised by a first framework section rigidly connectable to the chassis and a second framework section comprising the track assemblies 1,1′, the second framework section may be releasably connectable to the chassis 38 via the first framework section. The second framework section may for instance comprise the first and second connecting elements 23,24 of the track assemblies 1,1′ and optionally any of the third, fourth, fifth and sixth connecting elements 25,26,27,28 of the track assemblies. The first framework section may optionally constitute an integral part of the chassis 38 or may be pre-installed on a commercial vehicle. Other alternative solutions for a modular framework 29 will be obvious to the skilled person based on the present disclosure. Such alternative solutions may for instance include having the second framework section further divided into at least two second section halves, wherein each half is connected to a separate track assembly. Each of the second section halves may comprise a first and second connecting element for one of the track assemblies, and optionally any of the third, fourth and fifth connecting element. In yet further solutions, a vehicle may have any of the first to sixth connecting elements pre-installed on the chassis or as an integral part of the chassis.

In snow conditions, the front wheels of wheel-drive vehicles may advantageously be converted by a ski kit. An exemplary ski kit comprising a ski assembly 39 for each of the front wheels of a vehicle is shown in FIGS. 1, 2, 6 and 7. Each ski assembly 39 is mounted on a front wheel hub unit 40 of a front wheel-drive vehicle 2, wherein the wheel hub unit 40 comprises a wheel 41 and a brake caliper bracket fastened to a bracket mount on the hub unit by caliper mounting bolts. The ski assembly comprises a ski element 42 and a fastening arm 43 (i.e. a fastening assembly). The fastening arm 43 has a first end 44 and a second end 45, wherein the first end is pivotably connected to the ski element 42 around a pivot axis being transverse to the longitudinal direction of the ski element 42. The pivot connection allows the ski element to follow the terrain. The second end 45 features a ski fastening bracket 46 comprising two mounting bolt holes 47. The mounting bolt holes are arrangeable at positions corresponding to the positions of the caliper mounting bolts, such that the second end may be rigidly connected to the bracket mount by suitable mounting bolts 48 via the brake caliper bracket (i.e. via bolt holes for the caliper mounting bolts in the brake caliper bracket). Each mounting bolt 48 is dimensioned to replace a caliper mounting bolt and has a length such that the ski fastening bracket 46 may be rigidly connected to the bracket mount via the caliper mounting bolt holes of the brake caliper bracket. In this manner, the ski assembly may be easily mounted securely to the front wheel hub. Further, by being mounted to the front wheel hub the ski assembly obtains a very precise steering.

To allow use of the ski assembly on a vehicle with a front wheel drive, or all-wheel/four-wheel drive, without decoupling the front wheel drive, the ski element features a cut out 49 through which a lower section of the wheel 41 may extend. A further advantage of the cut out is that the vehicle may drive at least some distances on hard surfaces like asphalt without damaging the ski elements 42. In addition, the front wheels will also contribute to an increased traction or propulsion when used on soft ground. In the exemplary embodiment, the cut out is in the form of a hole in the ski element. However, in other embodiments, the cut out may be in the form of a recess. The recess arranged in the side of the ski element opposite the side at which the first end 44 of the fastening arm is connected. When the cut out is a recess, the ski assembly may be connected to the front wheel hub unit 40 without having to move or jack up the front wheel.

In the exemplary ski assembly, the ski element 42 features two support ribs 50 in the longitudinal direction of the ski element and arranged on opposite sides of the cut out 49. The support ribs provide increased stiffness and strength to the ski element. The first end is pivotably connected to the ski element 42 at one of the support ribs 50. Alternative solutions for obtaining a ski element having the required stiffness and strength are easily conceivable based on the present disclosure.

1. A ski assembly for mounting on a front wheel hub unit of a motorized wheel-drive vehicle, wherein the wheel hub unit comprises a wheel and a brake caliper bracket fastened to a bracket mount on the wheel hub unit by caliper mounting bolts, the ski assembly comprises a ski element and a fastening assembly, wherein
the fastening assembly comprises an arm having a first end and a second end, the first end is connected to the ski element and the second end comprises a ski fastening bracket comprising at least two mounting bolt holes arrangeable at positions corresponding to the positions of the caliper mounting bolts, such that the second end may be rigidly connected to the bracket mount via the brake caliper bracket.

2. A ski assembly according to claim 1, comprising at least two ski assembly mounting bolts, each bolt dimensioned to replace a caliper mounting bolt and having a length such that the ski fastening bracket may be rigidly connected to the bracket mount via the brake caliper bracket.

3. A ski assembly according to claim 1, wherein the ski element comprises a cut out through which a lower section of a wheel mounted on the wheel hub unit may extend.

4. A ski assembly according to claim 1, wherein the ski element comprises at least a first support rib arranged in the longitudinal direction of the ski element.

5. A ski assembly according to claim 4, wherein the first end is pivotably connected to the ski element at the first support rib.

6. A method of mounting a ski assembly to the front wheel hub unit of a motorized wheel-drive vehicle, the wheel hub unit comprises a wheel and a brake caliper bracket fastened to a bracket mount on the wheel hub unit by caliper mounting bolts, the method comprising the steps of:
providing a ski assembly according to any of claims 1-5 or 7;
unscrewing the caliper mounting bolts; and
connecting the ski fastening bracket to the bracket mount via the brake caliper bracket by use of ski assembly mounting bolts.

7. A ski assembly according to claim 1, wherein the first end of the arm is pivotally connected to the ski element
